(19) United States
(12) Patent Application Publication
(10) Pub. No.: US 2021/0225545 A1
(43) Pub. Date: Jul. 22, 2021

(54) Radioactive Waste Recycling Plant

(71) Applicants: Joint Stock Company "Rosenergoatom", Moscow (RU); Joint Stock Company "Science and Innovations", Moscow (RU)

(72) Inventors: Mikhail Anatol'evich POLKANOV, Moskovskaya obl. (RU); Vladimir Nikolaevich ROZIN, Voronezhskaya obl. (RU); Aleksandr Nikitovich SHAROV, Voronezhskaya obl. (RU); Aleksandr Pavlovich SHCHUKIN, Voronezhskaya obl. (RU)

(21) Appl. No.: 16/306,421

(22) PCT Filed: Dec. 8, 2017
(86) PCT No.: PCT/RU2017/000914

§ 371 Date: Nov. 30, 2018

(30) Foreign Application Priority Data
Dec. 6, 2017 (RU) 2017142623

(51) Int. Cl. G21F 9/30; G21F 9/02; F27B 1/18; F27B 1/21; F27B 1/26; F27B 1/28; F27D 17/00; F27D 21/00

(52) U.S. Cl. CPC G21F 9/308; G21F 9/02; F27B 1/18; F27B 1/21; F27D 2019/0003; F27B 1/28; F27D 17/008; F27D 21/0014; F27B 1/26

(57) ABSTRACT

Recycling of low and medium radioactivity nuclear waste from VVER and RBMK reactors and other nuclear installations.

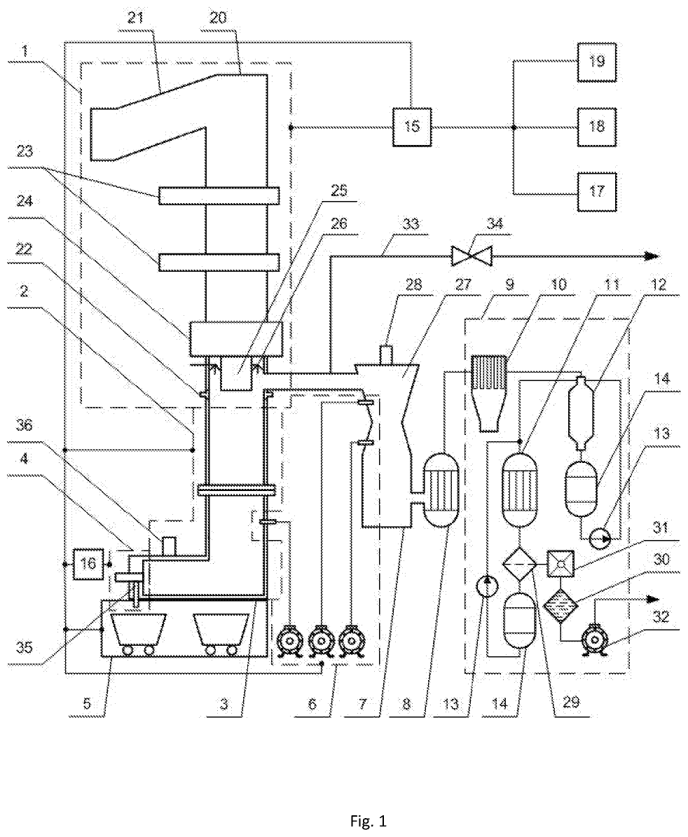

The invention uses a recycling plant consisting of a waste feed unit; a plasma shaft-type furnace with a melter in the hearth of the furnace and a slug discharge unit connected with a receiving tank for molten slug; an air supply unit delivering air to the furnace to a pyrolysis gas combustion chamber; an evaporative heat exchanger for sharp reduction of the flue gases temperature; a gas purification unit with a sock-type filter; a heat-exchanger and a scrubber; pumps and tanks for agents and recycled products; fittings; and at least, one control module which is electrically connected to the slug discharge control module, an interior environment control module, an equipment status control module and, at least, one gas analytical module.

### CROSS-REFERENCE TO RELATED APPLICATIONS

This application is a US 371 Application from PCT/RU2017/000914 filed Dec. 8, 2017, which claims priority to Russia Application 2017142623 filed Dec. 6, 2017, the technical disclosures of which are hereby incorporated herein by reference.

The alleged invention is related to nuclear power generation technologies and can be used for recycling of low and medium radioactivity waste, in particular, nuclear waste from VVER and RBMK reactors and other nuclear installations.

A system for treatment of radioactive and toxic waste which contains cellulose, polymeric compounds, resin, PVC and non-flammable admixtures, such as glass and metals is known wherein the generated combustion residues are further melted to transform into a solid mass (patent RF No 2107347).

Disadvantages of this system are as follows: low capacity of the feed system, large volume of flue gases, insufficient purification of flue gases from aerosol impurities and radioactive nuclides, lack of automatic or automated mode for recycling of radioactive waste.

The closest equivalent of the alleged invention is a nuclear waste recycling installation described in patent RF No 2320038, the installation contains the following equipment: a feed system, a plasma shaft-type furnace with a melter located in the hearth of the furnace and a slag discharge unit connected to the receiving tank for molten slag; an air supply unit to the furnace and pyrolysis gas combustion chamber; evaporative heat exchanger for sharp reduction of flue gas temperature; gas purification unit with a sock-type filter, a heat exchanger and a scrubber, pumps and tanks for chemical agents and recycled products, fittings.

Disadvantages of this technical solution are as follows: lack of possibility to alter or reconfigure the nuclear waste recycling process depending on the type of waste; low efficiency of waste recycling and low wear-resistance due to critically high operational parameters.

The objective of the alleged invention is to extend the functionality, enhance wear-resistance and efficiency of the recycling plant. The technical result of the invention is to design a flexible operation mode in which nuclear waste with different radioactivity level would be recycled in automatic or automated mode, and to ensure increased wear-resistance of the plant components.

This technical result is achieved in the radioactive waste recycling plant which consist of the following components: a waste feed unit, a plasma shaft-type furnace with a melter in the hearth of the furnace and a slug discharge unit connected with a receiving tank for molten slug; an air supply unit delivering air to the furnace to a pyrolysis gas combustion chamber; an evaporative heat exchanger for sharp reduction of the flue gases temperature; a gas purification unit with a sock-type filter; a heat-exchanger and a scrubber; pumps and tanks for agents and recycled products; fittings; the recycling plant (in accordance with the invention) is additionally equipped with, at least, one control module which is electrically connected to the slug discharge control module, an interior environment control module, an equipment status control module and, at least, one gas analytical module. The control module is electrically connected with the electric hardware of a waste feed unit, a plasma shaft-type furnace, a receiving tank for molten slug and with the electric hardware of the air supply unit which delivers the air to the furnace and to the combustion chamber, and the slug discharge control is electrically connected with the electric hardware of the slug discharge unit.

A control module for a slag discharge unit may include a digital video recorder, a temperature sensor for discharged slag, optical monitoring sensors located inside the receiving tank for molten slag; a light alarm system with lighting columns and an emergency button.

An interior environment control module may include, at least, temperature, pressure, flow and rarefication sensors, one sensor of each category.

An equipment status control module may include, at least, one fittings position transmitter and one pump control sensor.

A gas analytical module may include the following sensors: measuring sensors for gas concentration (oxygen, carbon monoxide, carbon dioxide, nitrogen oxide, nitrogen dioxide, aggregate concentration of nitrogen oxide, sulfur dioxide and aggregate concentration of hydrocarbons). The location for installation of the gas analytical module can chosen to provide for the monitoring of pyrolysis gas composition in the gas stack between the plasma shaft-type furnace and the combustion chamber, and/or to provide for the monitoring of flue gases in the gas stack between the combustion chamber and the evaporative heat exchanger, and/or at the outlet of the recycling plant.

Control module can be equipped by a data storage unit and data displaying screen, control module is a controller and/or computer, wherein inputs of the control module are electrically connected to the outputs of the slug discharge control module, interior environment control module, equipment status control module and, at least, to one gas analytical module. The outputs of the control module are electrically connected with the electric hardware inputs of the following equipment: a waste feed unit, a plasma shaft-type furnace, a receiving tank for molten slug, an air supply unit delivering air to the furnace and to the combustion chamber.

A waste feed unit may be equipped with a feed tank and a feed conveyor belt. The feed tank may be equipped with, at least, one proximity sensor and, at least, two airtight sliding shutters, a thermal screen and a feed spout.

A plasma shaft-type furnace may be equipped with centrifugal jet nozzles, which are part of the emergency sprinkle system and are installed in the upper part of the furnace.

The pyrolysis gas combustion chamber may be equipped with a pre-chamber and a plasma generator located in the top cover of pre-chamber, and with an additional air supply unit.

A gas purification unit may be additionally equipped with a separator filter and, at least, one fine filter.

A plasma shaft-type furnace and a combustion chamber may be additionally equipped with a gas discharge duct with emergency gas discharge valves and an emergency system of absorption purification, and the slug discharge unit may include a discharge block with a central hole and a stopper.

A plasma shaft-type furnace may have a split design and be equipped with, at least, one plasma generator (80-170 kWt), moreover, the furnace melter can be designed to enable its relocation if necessary, and the connection section between the slug discharge unit and the receiving tank for molten slag can also have a split design.

A waste feed unit may be equipped with a hopper to supply liquid flammable radioactive waste to the plasma shaft-type furnace.

Integration of, at least, one control module will provide for the automation of radioactive waste recycling.

Integration of a gas analytical module will allow for selecting the best operational parameters for the recycling plant.

An overall waste recycling plant layout is represented in below FIGURE.

A radioactive waste recycling plant includes (1) a waste feed unit, a plasma shaft-type furnace (2) with a melter (3) in the hearth and a slug discharge unit (4) which is connected to the receiving tank (5) for molten slug, an air supply unit (6) to supply air to the furnace (2) and to a pyrolysis gas combustion chamber (7), an evaporative heat exchanger (8) for sharp reduction of flue gas temperature, gas purification system (9) and fittings (not shown). A gas purification unit includes a sock-type filter (10), a heat exchanger (11), a scrubber (12), pumps (13) and tanks (14) for chemical agents and recycled products. A radioactive waste recycling plant also includes a control module (15) and the below listed modules which are electrically connected to the control module (15): a control module (16) for slug discharge unit (4); an interior environment control module (17); an equipment status control module (18) and a gas analytical module (19). The control module (15) is electrically connected to electric hardware of the following units: a waste feed unit (1), a plasma shaft-type furnace (2), a receiving tank for molten slug (5), an air supply unit (6) which supplies the air to the furnace (2) and to the combustion chamber (7). A control module (16) for a slag discharge unit (4) is electrically connected to the electric hardware of a slag discharge unit (4) and may include a digital video recorder, a temperature sensor for discharged slag, optical monitoring sensors (not shown in the FIGURE) located inside the receiving tank for molten slag; a light alarm system with lighting columns and an emergency button.

An interior environment control module (17) may include, at least, temperature, pressure, flow and rarefication sensors (not shown in the FIGURE), one sensor of each category.

An equipment status control module (18) may include, at least, one fittings position transmitter and one pump control sensor (not shown in the FIGURE).

A gas analytical module (19) includes concentration measuring sensors for the following gas: oxygen, carbon monoxide, carbon dioxide, nitrogen oxide, nitrogen dioxide, aggregate concentration of nitrogen oxide, sulfur dioxide and aggregate concentration of hydrocarbons (not shown in the FIGURE). The location for installation of the gas analytical module (19) can be chosen to provide for the monitoring of pyrolysis gas composition in the gas stack between the plasma shaft-type furnace (2) and the combustion chamber (7), and/or to provide for the monitoring of flue gases in the gas stack between the combustion chamber (7) and the evaporative heat exchanger (8), and/or at the outlet of the recycling plant.

A control module (15) is equipped with a data storage device and a data output module in a form of a display, either a PC and/or a controller can be used as a control module (15). Inputs of the control module (15) are electrically connected to the outputs (16) of the slug discharge (4) control module, interior environment control module (17), equipment status control module (18), and to gas analytical module (19). Wherein the outputs of the control module (15) are electrically connected with the electric hardware inputs of the waste feed unit (1), a plasma shaft-type furnace (2), a receiving tank (5) for molten slug, an air supply unit (6) delivering air to the furnace (2) and to the pyrolysis gas combustion chamber (7).

A waste feed unit (1) may be equipped with a feed tank (20) and a feed conveyor belt (21). The feed tank (20) may be equipped with, at least, one proximity sensor (22) and, at least, two airtight sliding shutters (23), a thermal screen (24) and a feed spout (25). A plasm shaft-type furnace (2) may be equipped with centrifugal jet nozzles (26) which are part of the emergency spray system and are installed in the upper part of the furnace.

The pyrolysis gas combustion chamber (7) may be equipped with a pre-chamber (27) and a plasma generator (28) located in the top cover of pre-chamber (27).

For more efficient combustion of pyrolysis gas the combustion chamber (7) can be additionally equipped with an air supply unit (6). At this point the air inlet from the air supply unit (6) can be made at the same level with the pyrolysis gas inlet in the pre-chamber (27), and an additional air inlet from the air supply unit (6) can be located in the upper part of the base volume of the combustion chamber (7). An air inlet from the air supply unit (6) to the plasma shaft-type furnace (2) is located in the bottom of the furnace.

A gas purification unit (9) can be additionally equipped with a separator filter (29) and, at least, one fine filter (30), and gas mixers (31) and exhaust fans (32).

The plasma shaft-type furnace (2) and pyrolysis gas combustion chamber (7) are equipped with a gas discharge duct (33) with emergency gas discharge valves (34) and an emergency system of absorption purification.

The slug discharge unit (4) may include a discharge block (35) with a central hole and a stopper.

A plasma shaft-type furnace (2) has a split design and is equipped with, at least, one plasma generator (36) (80-170 kWt), moreover, the furnace melter (3) can be designed to enable its relocation if necessary, for example, it can be placed on a portable trolley. Moreover, the connection section between the slug discharge unit (4) and the receiving tank (5) for molten slag also has a split design.

A waste feed unit (1) may be equipped with a hopper to supply liquid flammable radioactive waste to the plasma shaft-type furnace (2).

The air supply unit (6) supplying air to the furnace (2) and to the combustion chamber (7) includes blow fans.

The recycling plant functions as follows: Solid radioactive waste packed in craft bags are sent to the waste feed unit (1) where the operating personnel in consecutive stages put these bags onto the conveyor (21) to be further delivered to the feed tank (20). The control module (15) sends commands to the feed unit (1) which loads the portions of packed radioactive waste into the furnace (2). The plasma shaft-type furnace (2) includes all stages of conversion for radioactive waste: drying, pyrolysis, oxidation of coking residues and slug melting. The result of recycling process are the molten slug and pyrolysis gas.

The temperature at all stages of waste conversion is controlled with the control module (15). The blast air is supplied through the inlets of the air supply unit (6) which supplies the air to the furnace (2) and to the combustion chamber (7), the direction of blast air flow can be regulated by means of flaps. The molten slug is accumulated in the melter (3). The heating of the melter is provided with, at least, one plasma generator (36) with rated power of 80-170 kWt. From the melter (3) the molten slug passes through the slug discharge unit (4) and is fed to the airtight receiving tank (5) for molten slug. The slug discharge unit (4) is controlled by the slug discharge control module (16) which, in turn, is controlled by the control module (15). The molten slug is collected in metal containers with further holdup and cooling. Containers with molten slug are removed from the receiving tank (5) and by means of a manipulator are loaded into a non-returnable shielding container. All components of slug discharge unit (4) are controlled by means of the control module (15).

Pyrolysis gas generated inside the shaft-type furnace (2) is fed to the combustion chamber (7). The source of heat in the combustion chamber (7) is a plasma generator (28). At a start-up stage two fuel supply nozzles (not shown in the FIGURE) are used together with the plasma generator (28) to speed up the heating of the pyrolysis gas combustion chamber (7) and suppress the nitrogen oxides which are generated as a result of operation of, at least, one plasma generator (28). Functioning of fuel supply nozzles is supported with a diesel supply system and a compressed air supply system.

The blast air is supplied to the pre-chamber (27) through the air supply unit (6) inlets located in the upper and lower part of the combustion chamber (7). Flue gases heated in the combustion chamber (7) up to the temperature of +1200-1350° C. are fed to the evaporative heat exchanger (8) where their temperature is sharply reduced up to +200-250° C. Cooling is ensured by means of complete evaporation of water sprayed by pneumatic nozzles which are located in the upper part of the evaporative heat exchanger (8). After the evaporative heat exchanger (8) the flue gases are delivered to the sock-type filter (10) where most of solid aerosol particles (dust) are captured. Flue gases purified in the sock-type filter (10) are supplied to the scrubber (12) where the downstream gas flow is intensively sprayed with 4% alkaline solution.

In the scrubber (12) the flue gases are cooled up to 50±5° C. and additionally purified from acid gases and aerosols. After the scrubber (12) the flue gases are cooled up to 25-35° C. in the tube side of the heat exchanger (11). In the separator filter (29) cooled flue gases are separated from condensed moisture. In the gas mixers (31) the flue gases are heated and mixed with hot air, then flue gases pass fine filtration stage (30) and with exhaust fans they are directed to a ventilation stack.

Gas analytical modules (19) provide for the control over the condition of interior environment, in particular, they allow for assessment of concentration and identification of gases generated as a result of waste recycling process. Gal analytical modules (19) are stationary continuously-operated plants used for measuring concentration of the following gases: O₂ (oxygen), CO (carbon oxide), CO₂ (carbon dioxide), NO (nitrogen oxide), NO₂ (nitrogen dioxide), NOₓ (aggregate concentration of nitrogen oxides), SO₂ (sulfur dioxide) [symbol] CH (aggregate concentration of hydrocarbons). For measurement of CO, CO₂, CH₄ and SO₂ concentration an infrared absorption method is used, for NO, NO₂ and NOₓ—measurement a chemiluminescent method is used, for measurement of CH concentration a flame ionization method is used. Sampling method can be described as forced sampling and it involves using a flow booster. A sampling system provides for the filtration of the sample of mechanical impurities, removal of water vapors (for CO, CO₂, SO₂, CH₄ and O₂ measurement), delivering the sample to the measurement channel free from condensed water vapors, delivering the sample to CH measurement channel at a temperature of (190±10) ° C.

Control and monitoring of the plant operation is provided with the control module (15) which is connected with the interior environment control module (17), which, in turn, is connected with the interior environment sensors (not shown in the FIGURE). Information about the condition of the interior environment is displayed on the screen of the interior environment control module (17).

Functioning of the equipment status control module (18) depends on the information sent by the interior environment control module (17) to the control module (15), which, in accordance with integrated algorithms, generates command electric signals forwarded to the equipment status control module (18) Further on the equipment status control module (18), in accordance with its integrated algorithms, generates a corresponding control signal for the purpose to influence the operation of the respective equipment. When the necessary parameters of the interior environment are reached, the interior environment control sensors acquire this information and forward it to the interior environment control module (17). After that the interior environment control module (17) registers the information about the fact that the necessary parameters of the interior environment have been reached, and sends a respective signal to the control module (15) The control module (15) upon receipt of this signal sends a command to the equipment status control module (18) to cease its influence to the equipment.

Utilization of the alleged invention allows to provide a flexible operational mode for the radioactive waste recycling plant.

1. The radioactive waste recycling plant which consist of the following components: a waste feed unit, a plasma shaft-type furnace with a melter in the hearth of the furnace and a slug discharge unit connected with a receiving tank for molten slug; an air supply unit delivering air to the furnace to a pyrolysis gas combustion chamber; an evaporative heat exchanger for sharp reduction of the flue gases temperature; a gas purification unit with a sock-type filter; a heat-exchanger and a scrubber; pumps and tanks for agents and recycled products; fittings; the recycling plant, characterized by that it is additionally equipped with, at least, one control module which is electrically connected to the slug discharge control module, an interior environment control module, an equipment status control module and, at least, one gas analytical module. The control module is electrically connected with the electric hardware of a waste feed unit, a plasma shaft-type furnace, a receiving tank for molten slug and with the electric hardware of the air supply unit which delivers the air to the furnace and to the combustion chamber, and the slug discharge control is electrically connected with the electric hardware of the slug discharge unit.

2. Radioactive waste recycling plant of claim 1 characterized by that a control module for a slag discharge unit may include a digital video recorder, a temperature sensor for discharged slag, optical monitoring sensors located inside the receiving tank for molten slag; a light alarm system with lighting columns and an emergency button.

3. Radioactive waste recycling plant of claim 1 characterized by that an interior environment control module (1) may include, at least, temperature, pressure, flow and rarefication sensors, one sensor of each category.

4. Radioactive waste recycling plant of claim 1 characterized by that an equipment status control module (1) may include, at least, one fittings position transmitter and one pump control sensor.

5. Radioactive waste recycling plant of claim 1 characterized by that a gas analytical module may include the following sensors: measuring sensors for gas concentration (oxygen, carbon monoxide, carbon dioxide, nitrogen oxide, nitrogen dioxide, aggregate concentration of nitrogen oxide, sulfur dioxide and aggregate concentration of hydrocarbons). The location for installation of the gas analytical module can be chosen to provide for the monitoring of pyrolysis gas composition in the gas stack between the plasma shaft-type furnace and the combustion chamber, and/or to provide for the monitoring of flue gases in the gas stack between the combustion chamber and the evaporative heat exchanger, and/or at the outlet of the recycling plant.

6. Radioactive waste recycling plant of claim 1 characterized by that a control module (1) is equipped with a data storage device and a data output module in a form of a display, either a PC and/or a controller is used as a control module.

7. Radioactive waste recycling plant of claim 1 characterized by that inputs of the control module are electrically connected to the outputs of the slug discharge control module, interior environment control module, equipment status control module and, at least, to one gas analytical module. The outputs of the control module are electrically connected with the electric hardware inputs of the following equipment: a waste feed unit, a plasma shaft-type furnace, a receiving tank for molten slug, an air supply unit delivering air to the furnace and to the combustion chamber.

8. Radioactive waste recycling plant of claim 1 characterized by that the waste feed unit is equipped with a feed tank and a conveyor connected therewith.

9. Radioactive waste recycling plant of claim 1 characterized by that a waste feed unit may be equipped with a feed tank and a feed conveyor belt. The feed tank may be equipped with, at least, one proximity sensor and, at least, two airtight sliding shutters, a thermal screen and a feed spout.

10. Radioactive waste recycling plant of claim 1 characterized by that a plasm shaft-type furnace may be equipped with centrifugal jet nozzles which are part of the emergency spray system and are installed in the upper part of the furnace.

11. Radioactive waste recycling plant of claim 1 characterized by that a pyrolysis gas combustion chamber may be equipped with a pre-chamber and a plasma generator located in the top cover of pre-chamber, and with an additional air supply unit.

12. Radioactive waste recycling plant of claim 1 characterized by that a gas purification unit is additionally equipped with a separator filter and, at least, one fine filter.

13. Radioactive waste recycling plant of claim 1 characterized by that the plasma shaft-type furnace and pyrolysis gas combustion chamber are equipped with a gas discharge duct with emergency gas discharge valves and an emergency system of absorption purification.

14. Radioactive waste recycling plant of claim 1 characterized by that the slug discharge unit may include a discharge block with a central hole and a stopper.

15. Radioactive waste recycling plant of claim 1 characterized by that a plasma shaft-type furnace has a split design and is equipped with, at least, one plasma generator (1-80 kWt), moreover, the furnace melter is designed to enable its relocation if necessary, and the connection section between the slug discharge unit and the receiving tank for molten slag has a split design.
